(19) United States
(12) Patent Application Publication
(10) Pub. No.: US 2004/0101751 A1
(43) Pub. Date: May 27, 2004

(54) Nickel metal hydride storage battery

(76) Inventors: Yoshifumi Magari, Kobe-city (JP); Tadayoshi Tanaka, Osaka (JP); Hiroyuki Akita, Kobe-city (JP); Katsuhiko Shinyama, Kobe-city (JP); Atsuhiro Funahashi, Toyonaka-city (JP); Toshiyuki Nohma, Kobe-city (JP)

Correspondence Address: KUBOVCIK & KUBOVCIK, SUITE 710, 900 17TH STREET NW, WASHINGTON, DC, 20006

(21) Appl. No.: 10/625,724

(22) Filed: Jul. 24, 2003

(30) Foreign Application Priority Data
Jul. 24, 2002 (JP) 2002-215203

(51) Int. Cl. H01M 4/62; H01M 4/58; H01M 4/32

(52) U.S. Cl. 429/212; 429/218.2; 429/223

(57) ABSTRACT

A nickel metal hydride storage battery which includes a positive electrode containing nickel hydroxide as a active material, a negative electrode containing a hydrogen absorbing alloy which contains aluminum, a separator and an alkaline electrolyte, wherein a complex-forming agent which forms a complex with aluminum is included in the negative electrode.

### FIELD OF THE INVENTION

The present invention relates to a nickel metal hydride storage battery comprising a positive electrode including nickel hydroxide as an active material, a negative electrode including a hydrogen absorbing alloy containing aluminum, a separator and an alkaline electrolyte. More particularly, the present invention relates to a nickel metal hydride storage battery of this type which is characterized in that aluminum, which is released from the hydrogen absorbing alloy containing aluminum by charge and discharge of the battery, is prevented from being deposited on the positive electrode.

### BACKGROUND OF THE INVENTION

An alkaline storage battery has recently been used for cellular phones, electric vehicles, and the like. As the alkaline storage battery, a nickel metal hydride storage battery is preferably used from the standpoints of higher capacity and improved environmental safety as compared to a nickel cadmium storage battery.

There is, however, a problem with a nickel metal hydride storage battery that when the battery is repeatedly charged and discharged, metal included in the hydrogen absorbing alloy which is used for the negative electrode is partially dissolved in the alkaline electrolyte as metal ions. These metal ions deposit on the separator to reduce the insulation effect of the separator or deposit on the positive electrode to cause self discharge, to reduce discharge capacity of the battery, and to cause deterioration of high rate discharge characteristics.

As disclosed in Japanese Patent Laid-open Publication No. 7-335245, an alkaline storage battery has been-proposed in which a complex-forming agent, which forms a complex with metal ions from the hydrogen absorbing alloy dissolved in the alkaline electrolyte, and an amine are included in the alkaline electrolyte.

However, even if the complex-forming agent is included in the alkaline electrolyte, it is difficult to capture the metal ions to form a complex. Thus, there is still a problem that the metal ions deposit on the separator to reduce the insulation effect of the separator, or deposit on the positive electrode to cause self discharge, reduce discharge capacity of the battery, and cause deterioration of high rate discharge characteristics. Especially, when a hydrogen absorbing alloy containing aluminum is used, dissolved aluminum ions deposit on the positive electrode to cause self discharge, reduce discharge capacity of the battery, and cause deterioration of high rate discharge characteristics.

It is also a problem that the complex-forming agent forms ionic impurities when it is included in the alkaline electrolyte and causes self discharge by movement of the ions between the positive and negative electrodes.

### OBJECTS OF THE INVENTION

An object of the present invention is to solve the above-described problems of a nickel metal hydride storage battery comprising a positive electrode containing nickel hydroxide as an active material, a negative electrode containing a hydrogen absorbing alloy which contains aluminum, a separator and an alkaline electrolyte. Especially, it is an object of the present invention to improve the efficiency of capture of aluminum ions dissolved in the alkaline electrolyte in a nickel metal hydride storage battery comprising a hydrogen absorbing alloy containing aluminum, and prevent or minimize depositing of aluminum ions on the positive electrode to inhibit self discharge, reduction of discharge capacity and deterioration of high rate discharge characteristics.

### SUMMARY OF THE INVENTION

In the present invention, in order to solve the above-described problems, a complex-forming agent which forms a complex with aluminum is included in the negative electrode.

### BRIEF DESCRIPTION OF THE DRAWINGS

FIG. 1 is a cross section of a nickel metal hydride storage battery prepared in the Example.

[Explanation of Elements]

1: positive electrode

2: negative electrode (hydrogen absorbing alloy electrode)

3: separator

4: negative electrode can

5: positive electrode lead

6: sealing lid

7: negative electrode lead

8: insulation packing

9: positive electrode external terminal

10: coil spring

### DETAILED EXPLANATION OF THE INVENTION

When aluminum included in the hydrogen absorbing alloy of a negative electrode of a nickel metal hydride storage battery is released from the alloy as aluminum ions during charge and discharge of the battery, if a complex-forming agent which forms a complex with aluminum is included in the negative electrode, the aluminum ions are efficiently captured by the complex-forming agent before the aluminum ions dissolve in the alkaline electrolyte and form a complex. Movement of aluminum ions to the positive electrode is also inhibited and deposition of aluminum ions on the positive electrode is sufficiently prevented so as to suppress self discharge, reduction of discharge capacity and deterioration of high rate discharge characteristics. It is preferable to provide the complex-forming agent on a surface of the negative electrode to capture aluminum ions before they dissolve in the alkaline electrolyte.

When the complex-forming agent is included in the negative electrode, the problem of the complex-forming agent forming ionic impurities in the alkaline electrolyte, which cause self discharge by movement between the positive and negative electrodes, is avoided.

As the complex-forming agent, for example, an aromatic carboxylic acid, an amino polycarboxylic acid, and the like can be used. As the aromatic carboxylic acid chromotropic acid, sulfosalycylic acid, and the like can be used. As the amino polycarboxylic acid, trans-cyclohexane-1,2-diaminetetraacetic acid (CDTA), and the like can be used.

The above-described complex-forming agent is easily oxidized by oxygen to create carbonate ions, nitrate ions, and the like, and it may be possible that the carbonate ions, nitrate ions, and the like will likely deteriorate storage characteristics and high rate discharge characteristics. To prevent such problem, it is preferable that a layer comprising a hydroxide or oxide of an element selected from the group consisting of calcium, strontium, scandium, yttrium, lanthanoid and bismuth is formed on a surface of the positive electrode active material to inhibit generation of oxygen at the positive electrode during charge of the battery. A layer comprising a hydroxide or oxide of yttrium is desirable to sufficiently inhibit generation of oxygen.

Nitrate ions generated by oxidation of the complex-forming agent dissolve in the alkaline electrolyte and move between the positive and negative electrodes and cause self discharge. Therefore, a sulfonated separator which is capable of catching these ionic impurities is preferably used.

### Description of Preferred Embodiment

### EXAMPLE

An example of a nickel metal hydride storage battery of the present invention is described below. It is of course understood that the present invention can be modified within the scope and spirit of the appended claims.

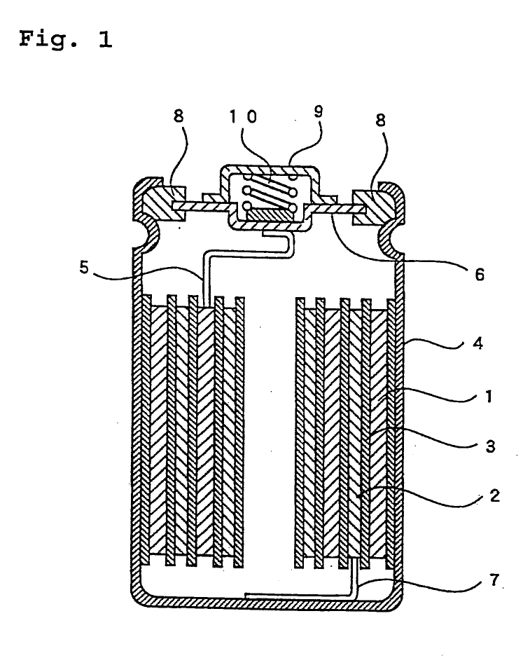

A cylindrical nickel metal hydride storage battery as shown in FIG. 1 was prepared.

As a hydrogen absorbing alloy for the active material of the negative electrode, particles of MmNi_{3.2}Co_{1.0}Al_{0.2}Mn_{0.6} comprising Misch Metal (Mm), which is a mixture of rare earth elements (La, Ce, Pr and Nd contained in a ratio by weight of 25:50:6:19), and Ni, Co, Al and Mn, and having an average diameter of about 50 μm were used in this Example.

To prepare the negative electrode a small amount of water was added to a mixture of 100 parts by weight of the hydrogen absorbing alloy particles and 1.0 part by weight of poly(ethylene oxide) as a binder to prepare a paste. The paste was coated on both sides of a nickel plated punched metal as a current collector. The coated punched metal was dried to prepare a negative electrode in which the hydrogen absorbing alloy particles are adhered on both sides of the punched metal.

To prepare a positive electrode a sintered nickel substrate having a porosity of 85% was immersed in a nickel nitrate solution containing cobalt nitrate and zinc nitrate by a chemical immersing method to impregnate the sintered nickel substrate with a positive electrode active material comprising nickel hydroxide containing cobalt and zinc. Then the sintered nickel substrate was dipped in a 3 weight % yttrium nitrate solution, and was dipped in a 25 weight % sodium hydroxide solution to prepare the positive electrode in which a layer of yttrium hydroxide was formed on the positive electrode active material.

A polyolefin nonwoven fabric was used as a separator. 30 weight % potassium hydroxide was used as an alkaline electrolyte.

The separator 3 was inserted between the positive electrode 1 and the negative electrode 2 and was rolled spirally, and was placed in a negative electrode can 4 as shown in FIG. 1. The alkaline electrolyte was poured into the negative electrode can 4 and the can was sealed. The positive electrode 1 was connected to a sealing lid 6 through a positive electrode lead 5, and the negative electrode 2 was connected to the negative electrode can 4 through a negative electrode lead 7. The negative electrode can 4 and sealing lid 6 were electrically insulated by an, insulation packing 8. A coil spring 10 was placed between the positive sealing lid and a positive electrode external terminal 9. The coil spring 10 is compressed and releases gas from inside of the battery to the atmosphere when pressure in the battery unusually increases.

Then the nickel metal hydride storage battery prepared in Example 1 was charged at 100 mA for 16 hours at a temperature of 25° C., and was discharged at 1000 mA to 1.0 V at a temperature of 25° C. (this charge and discharge cycle is considered one cycle) Charge and discharge of the battery were repeated for five cycles to activate the battery.

The activated nickel metal hydride storage battery was charged at 1000 mA for 24 minutes, charged at 10 A for two minutes, and then was discharged at 10 A for two minutes. Charge and discharge cycles were repeated (charge and discharge at 10 A is considered one cycle). The battery was discharged to a battery voltage of 1.0 V every 1000 cycles, and was charged at 1000 mA for 24 minutes. 20,000 cycles of charge and discharge at. 10 A were repeated.

The positive electrodes and separators were removed from an activated nickel metal hydride storage battery not subjected to the repeated charge and discharge cycles (“the activated only battery”) and from the battery subjected to the repeated 20,000 charge and discharge cycles (“the repeated cycle battery”) to measure the content of aluminum Al (weight %) relative to the total amount of the positive electrode and relative to the total amount of the separator. The results are shown in Table 1.

The activated only battery and the repeated cycle battery were charged at 1000 mA for 1.2 hours and were discharged at 1000 mA to 1.0 V to obtain discharge capacities (mAh). The results are shown in Table 1.

The activated only battery and the repeated cycle battery were charged at 500 mA for 1.6 hours at a temperature of 25° C. and were discharged at 500 mA to 1.0 V to obtain discharge capacities Qₒ (mAh) before storage. After they were charged at 500 mA for 1.6 hours at a temperature of 25° C., they were left at a temperature of 45° C. for 7 days and were discharged at 500 mA to 1.0 V to obtain discharge capacities Qₐ (mAh) after storage. A capacity maintenance rate (%) was calculated as follows:

Capacity maintenance rate(%)=(Qₐ/Qₒ)×100

The activated only battery and the repeated cycle battery were charged at 1000 mA for 0.5 hour and were discharged at a high current of 20 A to obtain a voltage (V) of each battery after 10 seconds from starting discharge. These results are shown in Table 1 as high rate discharge characteristics.

TABLE 1

| | Al Content | | | Capacity | High Rate |
|---|---|---|---|---|---|
| | (weight %) | | Discharge | Main- | Discharge |
| | Positive | | Capacity | tenance | Character- |
| | Electrode | Separator | (mAh) | Rate (%) | istics (V) |
| Activated | 0.09 | 0.09 | 1000 | 80 | 1.015 |
| only | | | | | |
| battery | | | | | |
| Repeated | 0.29 | 0.06 | 800 | 45 | 0.900 |
| cycle | | | | | |
| battery | | | | | |

The repeated cycle battery has a higher aluminum content in the positive electrode as compared with the activated only battery.

In the repeated cycle battery, discharge capacity and capacity maintenance rate which is affected by discharge capacity and self discharge, are lower than that of the battery without repeated cycles. The voltage of the repeated cycle battery when the battery was discharged at the high current is also lower than that of the activated only battery.

Therefore, if a complex forming agent which is capable of forming a complex with aluminum is included in a negative electrode comprising a hydrogen absorbing alloy containing aluminum, aluminum released from the hydrogen absorbing alloy is captured, by formation of a complex with the complex forming agent to prevent aluminum from being dissolved in an alkaline electrolyte. Thus, deposition of aluminum ion on a positive electrode is prevented and an increased aluminum content in the positive electrode is avoided. High rate discharge characteristics, capacity, and capacity maintenance rate, which is affected by discharge capacity and self discharge, are improved.

### Advantages of the Invention

The present invention can provide significant improvements in storage characteristics, discharge capacity and high rate discharge characteristics of a nickel metal hydride storage battery by including a complex-forming agent capable of forming a complex with aluminum in a negative electrode which includes a hydrogen absorbing alloy containing aluminum.

The present invention can also avoid ionic impurities generated from a complex-forming agent from being included in an alkaline electrolyte, which is a problem when the complex-forming agent is dissolved in the alkaline electrolyte.

What is claimed is:

1. A nickel metal hydride storage battery comprising a positive electrode comprising nickel hydroxide as a active material, a negative electrode comprising a hydrogen absorbing alloy containing aluminum, a separator and an alkaline electrolyte, wherein a complex-forming agent which forms a complex with aluminum is included in the negative electrode.

2. The nickel metal hydride storage battery according to claim 1, wherein the complex-forming agent is an aromatic carboxylic acid.

3. The nickel metal hydride storage battery according to claim 1, wherein a layer comprising a hydroxide or oxide of an element selected from the group consisting of calcium, strontium, scandium, yttrium, lanthanoids and bismuth is formed on a surface of the positive electrode active material.

4. The nickel metal hydride storage battery according to claim 2, wherein a layer comprising a hydroxide or oxide of an element selected from the group consisting of calcium, strontium, scandium, yttrium, lanthanoids and bismuth is formed on a surface of the positive electrode active material.
